(19) United States
(12) Patent Application Publication
(10) Pub. No.: US 2017/0094495 A1
(43) Pub. Date: Mar. 30, 2017

(54) METHOD FOR SUPPORTING PROXIMITY-BASED SERVICE CONFIGURING FOR UE

(71) Applicant: Samsung Electronics Co., Ltd, Gyeonggi-do (KR)

(72) Inventors: Xiaowan Ke, Beijing (CN); Hong Wang, Beijing (CN); Lixiang Xu, Beijing (CN)

(73) Assignee: Samsung Electronics Co., Ltd., Gyeonggi-do (KR)

(21) Appl. No.: 15/126,286

(22) PCT Filed: Feb. 17, 2015
(86) PCT No.: PCT/KR2015/001623

§ 371 Date: Sep. 14, 2016

(30) Foreign Application Priority Data
Mar. 14, 2014 (CN) 201410096427.6

(51) Int. Cl. H04W 8/00; H04W 4/02

(52) U.S. Cl. CPC H04W 8/005; H04W 4/023

(57) ABSTRACT

The present invention discloses a method for supporting ProSe configuration for a UE. In the method, a radio network node receives a ProSe configuration requirement transmitted from a UE, a ProSe function (ProSe Function), a source radio network node of the UE or a core network node to request ProSe configuration for the UE. The radio network node performs the ProSe configuration for the UE according to the ProSe configuration requirement.

### TECHNICAL FIELD

The present invention relates to a radio communication technology, and more particularly, to a method for supporting proximity-based service (ProSe) configuration for a user equipment (UE).

### BACKGROUND ART

In modern mobile communication, diverse services are provided to users. At present, U.S.A. public safety Department has already taken a LTE network as a basis communication network of a public safety information service. A proximity-based services (also called as device to device (D2D) service) among UEs is an important component of public safety communication requirements, which includes ProSe direct discovery among UEs and ProSe direct communication among UEs. The ProSe direct discovery among UEs may be a basis of direct communication among the UEs. It can be perceived whether a friend user exists in a user's neighborhood. And then the user is prompted to perform a next operation. In a public safety field, it is helpful for members of a public safety enforcement division to perform mission control in a specific outdoor environment and to perform coordination with each other. Furthermore, security is provided via a confidential way. There is a flexible application in a commerce field. In particular, a field social network can be fast formed. For example, proximate users having a same interest can discover each other, or can push a commerce advertisement to each other.

FIG. 1 is a schematic diagram illustrating a structure of a system for a ProSe. In FIG. 1, a user equipment (UE) 101 is a terminal device supporting a ProSe. An evolved universal terrestrial radio access network (E-UTRAN) 102 is a radio access network, and includes an evolved node base station (eNodeB) that can provide a radio interface for UEs and can provide service scheduling and configuration for the UE 101. A mobility management entity (MME) 103 is used to manage mobile context, session context and security information of the UE. A home subscriber server (HSS) 104 is a home sub-system, and is used for protecting user information such as a current position of a user device, an address of a service node, user security information, packet data context of the user device, and user access service subscription. A proximity-based service function (ProSe Function) 105 is used for storing user information including a user device of a ProSe user, a discovered identifier used, security information of the user's ProSe, and ProSe context of the user.

In a ProSe process, there are a role of UE transmitting a signal and a role of UE monitoring a signal. By monitoring information transmitted by a UE transmitting a signal in neighborhood, a UE monitoring a signal identifies a UE or a user in neighborhood, or performs ProSe direct communication with the UE in neighborhood. In the scenario of in coverage of network, radio resources of a UE transmitting a signal are configured by a network through a configuration way type 1, i.e., all UEs or a group of UEs are configured with common radio resources, each UE or each UE in the group can use the radio resources through competition. Alternatively, radio resources of a UE transmitting a signal are configured by a network through an configuration way type 2, i.e., each UE is configured with a dedicated resource.

### DISCLOSURE OF INVENTION

### Technical Problem

In the ProSe at present, the following problems still exist. The resource configuration for the ProSe direct communication service also has two types: mode1 and mode2. For mode1, each UE or each UE group is configured with dedicated resources. For mode2, configured radio resources are shared by UEs.

Problem 1: configuration requirements are different for different ProSe services, e.g., a UE transmitting a signal is configured with transmission resources, the transmission resources can be shared or dedicated for specific UE, but a UE monitoring a signal is configured with monitoring resources.

Problem 2: different ProSe services have different requirements for eNB capabilities, e.g., eNB should be involved for dedicated resource configuration, or for sharing resource configuration, UEs can select the resources from a resource pool, but the UE monitoring a signal is only required to obtain resources to be monitored from a network broadcast.

Problem 3: when initiating a ProSe service request from a UE to an eNB which the UE accesses, the UE cannot determine whether the eNB has a capability of supporting a corresponding ProSe service.

Problem 4: when a UE is moving in a process of using a ProSe, an eNB cannot know whether a neighbor eNB support the ProSe, and cannot select a suitable target cell for the UE.

Problem 5: when a UE in a group initiates ProSe service establishment, it is not clear whether resources are configured for the UE, when a UE in a group moves, it is not clear whether UE resources are maintained in a source cell or new resources are reconfigured in a target cell.

### Solution to Problem

A method for supporting ProSe configuration for a UE is provided according to embodiments of the present invention so as to reasonably perform ProSe configuration for the UE.

In order to implement the intention above, the present invention provides a technical solution as follows.

A method for supporting ProSe configuration for a UE includes:

a, receiving a ProSe configuration requirement, wherein the ProSe configuration requirement is used to request ProSe configuration for a UE; and

b, performing the ProSe configuration for the UE according to the ProSe configuration requirement.

Preferably, the ProSe configuration requirement includes: a ProSe type, wherein the ProSe type includes at least one service type or a combination of at least two service types as follows: a proximate discovery service, a ProSe direct communication service, a ProSe direct discovery service of discovering another UE, a ProSe direct discovery service to be discovered by another UE, a proximate discovery service of the UE, a proximate discovery service for a designated target UE, a ProSe service via UE sharing resources, a ProSe via UE dedicated resources, a ProSe direct communication service, an one-to-one ProSe direct communication service, an one-to-multiple ProSe direct communication service, a direct ProSe, a ProSe via a relay, a ProSe assisted via a network, a ProSe by centralized scheduling resources, a proximate server that the UE obtains distributed resources.

Preferably, when the ProSe type includes multiple service types or a combination of the multiple service types, and the ProSe configuration requirement includes ProSe configuration requirements respectively corresponding to different the multiple service types.

Preferably, the ProSe configuration requirement includes a UE type, wherein the UE type includes a UE transmitting a signal and/or a UE monitoring a signal.

Preferably, the ProSe configuration requirement corresponding to the ProSe direct communication service further includes UE group information, wherein the UE group information includes a group identifier or a grouping filter condition.

Preferably, the ProSe configuration requirement further includes a ProSe priority of the UE, so that a radio network node accessed by the UE or a handover target radio network node can perform scheduling and resource configuration according to the ProSe priority of the UE.

Preferably, a radio network node receives the ProSe configuration requirement, and performs the ProSe configuration.

Preferably, the radio network node includes a radio network node accessed by the UE or a target radio network node.

Preferably, the ProSe configuration requirement in step a is transmitted by a ProSe function (ProSe Function) or a core network node.

Preferably, the ProSe Function or the core network node transmitting the ProSe configuration requirement includes:

receiving, by the core network node, a ProSe request transmitted by the UE via the radio network node accessed by the UE, and transmitting the ProSe configuration requirement after the UE passes through authentication according to ProSe subscription of the UE and/or a ProSe capability of the radio network node accessed by the UE to request the ProSe configuration for the UE; or

receiving, by the ProSe Function, a ProSe request directly transmitted by the UE or transmitted by the UE via the radio network node accessed by the UE, and transmitting the ProSe configuration requirement after the UE passes through authentication according to ProSe subscription of the UE and/or a ProSe capability of the radio network node accessed by the UE to request the ProSe configuration for the UE.

Preferably, the ProSe capability of the radio network node accessed by the UE includes: a capability whether the ProSe is supported, a capability whether the proximate discovery service is supported, a capability whether the ProSe direct communication service is supported, a capability whether the proximate discovery service of discovering another UE is supported, a capability whether the proximate discovery service to be discovered by another UE is supported, a capability whether the proximate discovery service of the UE is supported, a capability whether the proximate discovery service for a designated target UE is supported, a capability whether the ProSe direct communication service is supported, a capability whether the one-to-one ProSe direct communication service is supported, a capability whether the one-to-multiple ProSe direct communication service is supported, a capability whether the direct ProSe is supported, a capability whether the ProSe via a relay is supported, a capability whether the ProSe assisted via a network is supported, a capability whether sharing resources are configured for the ProSe of the UE is supported, a capability whether dedicated resources are configured for the ProSe of the UE is supported, a capability whether the ProSe by centrally scheduling resources is supported, a capability whether the ProSe that the UE obtains distributional resources is supported; and/or

The ProSe subscription includes: whether the UE is allowed to use the ProSe, whether the UE is allowed to use the proximate discovery service, the UE is allowed to use the ProSe direct communication service, whether the UE is allowed to use the proximate discovery service of discovering another UE, whether the UE is allowed to use the proximate discovery service to be discovered by another UE, whether the UE is allowed to use the proximate discovery service of the UE, whether the UE is allowed to use the proximate discovery service for a designated target UE, whether the UE is allowed to the ProSe direct communication service, whether the UE is allowed to the one-to-one ProSe direct communication service, whether the UE is allowed to the one-to-multiple ProSe direct communication service, a capability whether the direct ProSe, whether the UE is allowed to the ProSe via a relay is supported, a capability whether the ProSe assisted via a network, whether the UE is allowed to the ProSe via sharing resources, whether the UE is allowed to the ProSe via dedicated resources, whether the UE is allowed to the ProSe by centrally scheduling resources, whether the UE is allowed to use the proximate server that UE obtains distributed resources.

Preferably, the method further includes:

obtaining, by the core network node, the ProSe capability of the radio network node accessed by the UE via the radio network node accessed by the UE; or

obtaining, by the ProSe Function, the ProSe capability of the radio network node accessed by the UE via the radio network node accessed by the UE.

Preferably, the ProSe configuration requirement in step a is transmitted from a source radio network node of the UE to a target radio network node of the UE; the ProSe configuration in step b is performed by the target radio network node.

Preferably, the target radio network node receiving the ProSe configuration requirement transmitted from the source radio network node includes:

after the UE moves from coverage of the source radio network node to coverage of the target radio network node, receiving, by the target radio network node, a ProSe configuration request transmitted by the UE, wherein the ProSe configuration request carries identifier information of the source radio network node and/or identifier information of the UE in the source radio network node, determining, by the target radio network node, the source radio network node according to the identifier information of the source radio network node transmitted by the UE and/or the identifier information of the UE in the source radio network node, obtaining ProSe context of the UE including the ProSe configuration requirement from the source radio network node; or

receiving, by the target radio network node, a ProSe configuration request directly transmitted from the source radio network node or transmitted through the core network node, wherein the ProSe configuration requirement is indicated in the ProSe configuration request, the target radio network node is selected by the source radio network node for the UE; or

transmitting, by the target radio network node, a ProSe context request of the UE or a ProSe configuration requirement request of the UE to the source radio network node, receiving the ProSe configuration requirement responded from the source radio network node.

Preferably, the identifier information of the source radio network node includes an identifier of the source radio network node, an IP address of the source radio network node, or an identifier of a source cell; and/or

the identifier information of the UE in the source radio network node includes a UE identifier, an identifier configured for the UE by the source radio network node, a resource identifier configured for the ProSe of the UE, an identifier of the ProSe of the UE and/or an identifier of a group to which the UE belongs.

Preferably, after the target radio network node performs the ProSe configuration for the UE, the method further includes:

indicating, by the target radio network node, the source radio network node to release the ProSe context or ProSe resources; and/or

notifying, by the target radio network node, the core network node that ProSe configuration for the UE is changed to ProSe configuration under the target radio network node; and/or

transmitting, by the target radio network node, configuration information to the UE directly or through the source radio network node.

Preferably, the target radio network node is selected by the source radio network node for the UE, when the source radio network node selects the target radio network node,

when all selectable target radio network node do not support the ProSe, the source radio network node does not hand over the UE, or the source radio network node does not request the selected target radio network node to perform the ProSe configuration for the UE; the source radio network node releases the ProSe context of the UE or ProSe resources of the UE before or after handover.

Preferably, the target radio network node is selected by the source radio network node for the UE; before the source radio network node selects the target radio network node for the UE, the method further includes:

obtaining, by the source radio network node, a ProSe capability supported by a neighbor cell or a ProSe capability supported by a neighbor radio network node from a measurement report of the UE; or obtaining, by the source radio network node, a ProSe capability supported by a neighbor cell or a ProSe capability supported by a neighbor radio network node by interacting via a X2 interface.

Preferably, when the ProSe type is a service type requiring transmission information or the UE is a UE of transmitting a signal, the radio network node accessed by the UE or the target radio network node performing the ProSe configuration for the UE includes: for sharing resources, indicating, by the radio network node accessed by the UE or the target radio network node, a sharing resource pool for the UE, or indicating the UE to monitor a broadcast of the sharing resource pool; for dedicated resources, configuring, by the radio network node accessed by the UE or the target radio network node, dedicated resources for the UE, and storing the ProSe context of the UE, wherein the ProSe context of the UE includes a UE identifier, and information of the occupied dedicated resources; and/or

when the ProSe type is a service type of requiring monitoring information or the UE is a UE of monitoring a signal, the radio network node accessed by the UE or the target radio network node performing the ProSe configuration for the UE includes: performing monitoring configuration for the UE; wherein performing the monitoring configuration for the UE includes: indicating the UE to monitor a broadcast of a monitoring resource pool, or notifying the resource pool to be monitored to the UE; and/or

when the ProSe configuration requirement is a configuration requirement of the ProSe of centrally scheduling resources, the radio network node accessed by the UE or the target radio network node performing the ProSe configuration for the UE includes: scheduling and configuring, by the radio network node, resources to be used in the ProSe; and/or

when the ProSe configuration requirement is a configuration requirement of the ProSe that the UE obtains distributional resources, the radio network node accessed by the UE or the target radio network node performing the ProSe configuration for the UE includes: indicating the sharing resource pool for the UE, or indicating the UE to monitor the broadcast of the ProSe sharing resource pool, or not performing configuration; and/or

when the ProSe configuration requirement is a configuration requirement of the ProSe, the radio network node accessed by the UE or the target radio network node performing the ProSe configuration for the UE includes: when there are not dedicated resources configured for a group in the radio network node accessed by the UE or the target radio network node, configuring, by the radio network node accessed by the UE or the target radio network node, the sharing resources for the group, storing ProSe context, wherein the storing ProSe context includes a UE group identifier and information of the sharing resources occupied by the group; when the dedicated resources for the group have been configured, indicating, by the radio network node accessed by the UE or the target radio network node, the dedicated resources for the UE, and adding the UE to the ProSe context; and/or

when the ProSe configuration requirement includes a ProSe priority of the UE, performing, by the radio network node accessed by the UE or the target radio network node, scheduling and configuration according to the ProSe priority of the UE.

Preferably, performing the monitoring configuration for the UE includes:

indicating the UE to monitor the monitoring configuration from a serving cell and or a neighbor cell.

Preferably, before performing the monitoring configuration for the UE, the method further includes:

transmitting, by the radio network node accessed by the UE or the target radio network node, the monitoring configuration of a cell belonging to the radio network node to a neighbor radio network node, and receiving the monitoring configuration of a cell belonging to the neighbor radio network node.

A radio network node device includes:

a ProSe configuration requirement receiving module, configured to receive a ProSe configuration requirement, trigger a ProSe configuration module to perform ProSe configuration;

the ProSe configuration module, configured to perform the ProSe configuration for the UE according to the ProSe configuration requirement received by the ProSe configuration requirement receiving module.

It can be seen from the above that, the method provided according to a technical solution of the present invention is used to configure multiple ProSes for the UE using a ProSe. In a scenario that the UE is moving, different solutions are provided. Especially, flexible solutions are provided for an eNB to obtain a ProSe capability. A flexible solution is provided for a proximate discovery solution according to the present invention so as to provide diversification network experience for the UE and to satisfy common security and a communication service requirement in a social network field.

### BRIEF DESCRIPTION OF DRAWINGS

FIG. 1 is a schematic diagram illustrating a structure of a system for a ProSe;

FIG. 2a is a basic flowchart illustrating a first method for supporting ProSe configuration for a UE according to an embodiment of the present invention;

FIG. 2b is a basic flowchart illustrating a second method for supporting ProSe configuration for a UE according to an embodiment of the present invention;

FIG. 2c is a basic flowchart illustrating a third method for supporting ProSe configuration for a UE according to an embodiment of the present invention;

FIG. 2d is a basic flowchart illustrating a fourth method for supporting ProSe configuration for a UE according to an embodiment of the present invention;

FIG. 3 is a flowchart illustrating a method for supporting ProSe configuration for a UE according to embodiment 1 of the present invention;

FIG. 4 is a flowchart illustrating a method for supporting ProSe configuration for a UE according to embodiment 2 of the present invention;

FIG. 5 is a flowchart illustrating a method for supporting ProSe configuration for a UE according to embodiment 3 of the present invention;

FIG. 6 is a flowchart illustrating a method for supporting ProSe configuration for a UE according to embodiment 4 of the present invention;

FIG. 7 is a flowchart illustrating a method for supporting ProSe configuration for a UE according to embodiment 5 of the present invention;

FIG. 8 is a flowchart illustrating a method for supporting ProSe configuration for a UE according to embodiment 6 of the present invention;

FIG. 9 is a flowchart illustrating a method for supporting ProSe configuration for a UE according to embodiment 7 of the present invention;

FIG. 10 is a flowchart illustrating a method for supporting ProSe configuration for a UE according to embodiment 8 of the present invention;

FIG. 11 is a flowchart illustrating a method for supporting ProSe configuration for a UE according to embodiment 9 of the present invention;

FIG. 12 is a flowchart illustrating a method for supporting ProSe configuration for a UE according to embodiment 10 of the present invention;

FIG. 13 is a schematic diagram illustrating a structure of a radio network node according to an embodiment of the present invention.

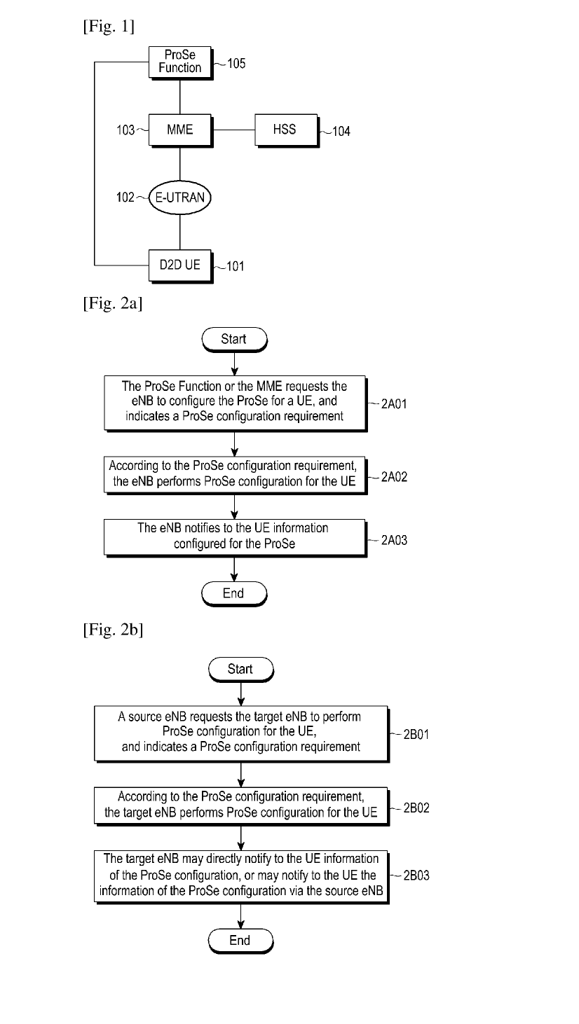

### MODE FOR THE INVENTION

In order to make the object, technical solution and merits of the present invention clearer, the present invention will be illustrated in detail hereinafter with reference to the accompanying drawings and specific examples.

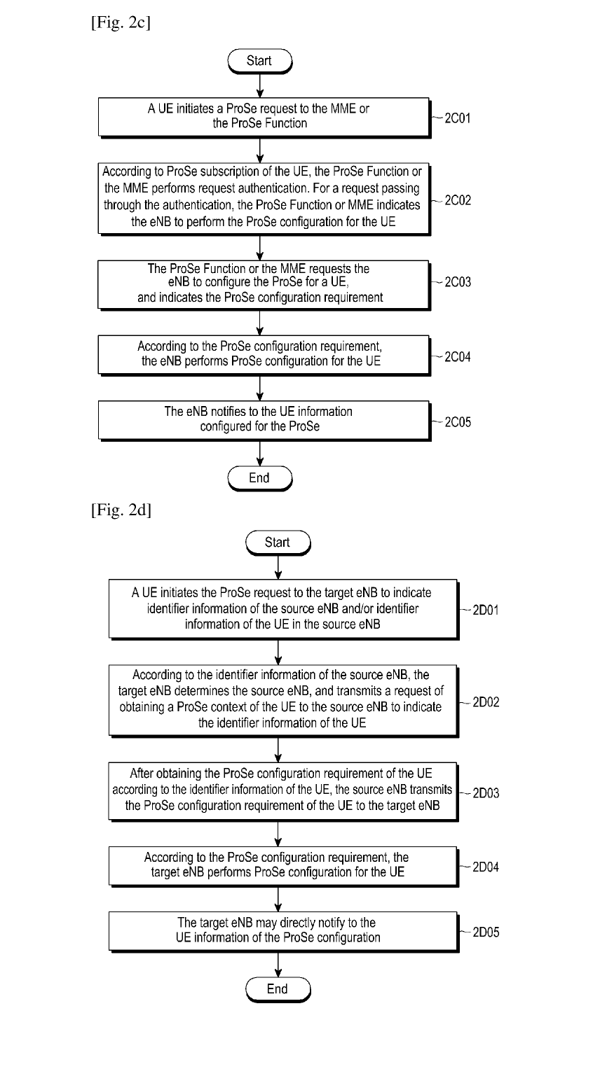

In embodiments as follows, an eNB is taken as a radio network node, and a MME is taken as a core network node. According to embodiments of the present invention, a ProSe configuration requirement is received. According to the ProSe configuration requirement, a ProSe is configured for the UE using the ProSe. The ProSe configuration requirement may be received and configured by an eNB accessed by the UE or a target eNB of the UE. The ProSe configuration requirement may be transmitted by a network node such as a ProSe function (ProSe Function), a source eNB of the UE using the ProSe or a MME. The method according to embodiments of the present invention includes basic procedures as shown in FIG. 2A-2D.

FIG. 2A is a flowchart illustrating a first method for supporting ProSe configuration for a UE according to an embodiment of the present invention. In this method, a ProSe configuration requirement is transmitted from a ProSe Function or a MME to an eNB. According to the ProSe configuration requirement, the eNB performs ProSe configuration. As shown in FIG. 2A, the method includes procedures as follow.

At block 2A01, the ProSe Function or the MME requests the eNB to configure the ProSe for a UE, and indicates the ProSe configuration requirement.

The MME may indicate information of the ProSe configuration requirement for the eNB through a UE context request, a UE context modification request, an E-RAB establishment request, an E-RAB modification request, a handover request, a confirmation message for a path handover request, or another S1 message.

The ProSe includes one or more service types or a combination of some service types: a ProSe, a proximate discovery service, a ProSe direct communication service, a proximate discovery service of discovering another UE, a ProSe to be discovered by another UE, a ProSe of the UE (i.e., a proximate discovery service that the UE broadcasts information of the UE itself), a proximate discovery service for a designated target UE (i.e., a proximate discovery service that the UE broadcasts information of the target UE), a ProSe via UE sharing resources, a ProSe via UE dedicated resources, a ProSe direct communication service, an one-to-multiple ProSe direct communication service (in the one-to-multiple ProSe direct communication service, various UEs are not limited to belong to a same UE group), an one-to-one ProSe direct communication service, a direct ProSe direct communication service (i.e., UEs directly communicate with each other, and may not communicate via an infrastructure network bearer), a ProSe via a relay, a ProSe assisted via a network, a ProSe by centrally scheduling resources (the resources are scheduled by an eNB and/or a relay or a central UE). In an example of combination of some service types, the proximate discovery service and the ProSe via UE sharing resources are combined as a proximate discovery service of UE sharing resources.

The ProSe configuration requirement of the UE may be a configuration requirement of a general ProSe of the UE (including the proximate discovery service and the ProSe direct communication service), or may be further divided into a configuration requirement of the proximate discovery service and/or a configuration requirement of the ProSe direct communication service. Furthermore, according to the ProSes above, the configuration requirement of the proximate discovery service and/or the configuration requirement of the ProSe direct communication service may be further subdivided.

The ProSe configuration requirement (the ProSe includes the proximate discovery service and the ProSe direct communication service) may further include transmission resource configuration and/or monitoring resource configuration. Monitoring resource configuration may be performed for the proximate discovery service of discovering another UE, or may be performed to monitor a signal of another UE. Transmission resource configuration may be performed for the proximate discovery service to be discovered by another UE, or may be performed to transmit a signal of the UE. The two configurations may be required at the same time for the ProSe of the UE. A ProSe type corresponding to the monitoring resource configuration may be a ProSe type for which monitoring configuration information is required, which may include the ProSe, the proximate discovery service, the ProSe direct communication service, the ProSe of discovering another UE, the ProSe via UE sharing resources, the ProSe via UE dedicated resources, the ProSe direct communication service, the one-to-multiple ProSe direct communication service, an one-to-one ProSe direct communication service, the direct ProSe direct communication service, the ProSe via a relay, the ProSe assisted via a network and/or the ProSe by centrally scheduling resources. A ProSe type corresponding to the transmission resource configuration may be a ProSe type for which transmission configuration information is required, which may include the ProSe, the proximate discovery service, the ProSe direct communication service, the ProSe to be discovered by another UE, the ProSe of the UE, the proximate discovery service for a designated target UE, the ProSe via UE sharing resources, the ProSe of UE dedicated resources, the ProSe direct communication service, the one-to-multiple ProSe direct communication service, the one-to-one ProSe direct communication service, the direct ProSe direct communication service, the ProSe via a relay, the ProSe assisted via a network and/or the ProSe by centrally scheduling resources.

Monitoring resources are configured for the proximate discovery service of discovering another UE. Transmission resources (e.g. Discovery resources) are configured for the proximate discovery service to be discovered by another UE.

A ProSe configuration requirement for transmission resources of the UE (the ProSe includes the proximate discovery service and the ProSe direct communication service) may further include a configuration requirement of sharing resources and/or a configuration requirement of dedicated resources. The configuration requirement of sharing resources may be performed by the UE, and may not be indicated to the eNB for performing configuration.

The ProSe configuration requirement of the UE (the ProSe includes the proximate discovery service and the ProSe direct communication service) may further include a configuration requirement of resources centrally scheduled and/or a configuration requirement of distributional resources obtained by the UE. The configuration requirement of the distributional resources obtained by the UE may be performed by the UE, and may be not indicated to the eNB for performing configuration.

The ProSe configuration requirement of the UE may further include a UE type. The UE type may be a UE transmitting a signal and/or a UE monitoring a signal. For the UE transmitting a signal, the ProSe configuration requirement of the UE may further indicate an eNB to configure sharing transmission resources or dedicated transmission resources. For the UE monitoring a signal, the monitoring resources are configured. And, the ProSe configuration requirement may further indicate an eNB to configure the radio resources to be monitored for the UE. Transmission resource configuration may include configuring time-frequency resources for the UE transmitting a signal. Monitoring resource configuration may include time-frequency resources for the UE monitoring a signal to monitor information transmitted by the UE transmitting a signal.

Furthermore, the ProSe configuration requirement of the UE may further include UE group information used for indicating a group identifier or a grouping filter condition. Furthermore, the ProSe configuration requirement of the UE may further indicate a resource valid time. When the time expires, the UE releases the resources.

The ProSe configuration requirement of the UE may be configured in the eNB. When the ProSe Function or the MME indicates the ProSe configuration requirement for the eNB, only the ProSe configuration requirement is indicated, which may include the ProSe types above, the UE types above, an indicator of a configuration requirement corresponding to the ProSe, an identifier of the configuration requirement corresponding to the ProSe, and/or a QoS class identifier (QCI) corresponding to the ProSe.

Furthermore, the ProSe configuration requirement may further include a ProSe priority of the UE.

At block 2A02, according to the ProSe configuration requirement, the eNB performs ProSe configuration for the UE.

The eNB may perform the ProSe configuration for the UE directly according to the received ProSe configuration requirement of the UE. Alternatively, according to a ProSe configuration requirement corresponding to a received ProSe configuration requirement indicator, the eNB may perform the ProSe configuration for the UE.

The configuration performed according to the received ProSe configuration requirement of the UE includes one or more items as follows:

1) A ProSe configuration requirement for transmission resources: for a configuration requirement for sharing resources, the eNB indicates a sharing resource pool, or indicates the UE to monitor a broadcast of the sharing resource pool of the ProSe, or the eNB may not perform any configuration. For a configuration requirement for dedicated resources, the eNB configures the dedicated resources for the UE, and stores ProSe context of the UE at the same time. The ProSe context includes information of a relationship between a UE and dedicated resources occupied by the UE or information of a relationship between a UE group and dedicated resources occupied by the UE group. Furthermore, for the configuration requirement for the dedicated resources, the eNB may directly configure a valid time of the dedicated resources for the UE, or may directly generate a valid time of the resources. The eNB may directly obtain the configuration requirement for the transmission resources from the ProSe configuration requirement, or may deduce the configuration requirement for the transmission resources from a ProSe type in the ProSe configuration requirement. The ProSe type requiring the configuration requirement for the transmission resources is as described at block 2A01.

2) A ProSe configuration requirement for monitoring resources: the eNB indicates the UE to monitor a broadcast of a monitoring resource pool, or notifies to the UE the monitoring resource pool to be monitored, or the eNB may not perform any configuration. The eNB may directly obtain the configuration requirement for the monitoring resources from the ProSe configuration requirement, or may deduce the configuration requirement for the monitoring resources from a ProSe type in the ProSe configuration requirement. The ProSe type requiring the configuration requirement for the monitoring resources is as described at block 2A01.

3) Furthermore, according to the ProSe priority of the UE in the ProSe configuration requirement, the eNB may perform configuration, scheduling and resource configuration for the UE.

4) For the ProSe configuration requirement for resources centrally scheduled, the eNB may schedule and configure resources required by the ProSe. For the configuration requirement for distributional resources obtained by the UE, the eNB indicates the sharing resource pool, or indicates the UE to monitor a broadcast of the sharing resource pool of the ProSe, or the eNB may not perform any configuration.

5) For the configuration requirement of a ProSe of the UE, according to a group identifier or a grouping filter condition, the eNB performs ProSe configuration for the UE. For the configuration requirement for group dedicated resources, when there are not dedicated resources configured for the group in the eNB, the eNB configures the group dedicated resources, stores ProSe context. When the group dedicated resources have been configured, the eNB indicates the group dedicated resources to the UE, and adds the UE into the ProSe context. The ProSe context may include information of a relationship between the UE and the dedicated resources occupied by the UE, or information of a relationship between the UE group and the dedicated resources occupied by the UE group. The configuration requirement for the group sharing resources is same with the ProSe configuration requirement for the sharing resources.

6) For the ProSe configuration requirement of the transmission resources, according to a ProSe capability supported by the eNB, when only sharing resource configuration is supported by the eNB, the eNB performs sharing resources configuration for the UE. When only specific resource configuration is supported by the eNB, the eNB performs specific resource configuration for the UE. When the two resource configurations above are supported, the eNB may select a resource configuration type.

7) When the ProSe configuration requirement for resources centrally scheduled, the eNB schedules and configures resources required by the ProSe. When only a configuration requirement for resources centrally scheduled is supported, the eNB may perform the central scheduling configuration for the UE. When a configuration requirement for distributional resources obtained by the UE, the eNB may perform configuration for the distributional resources obtained for the UE. When the two resource configurations above are supported by the eNB, the eNB may select a type of the resource configurations.

At block 2A03, the eNB notifies to the UE information configured for the ProSe. The information configured for the ProSe of the UE is same as configuration performed by the eNB according to the received ProSe configuration requirement of the UE at block 2A02. Procedures at this block are optional. In a configuration processing for some D2D services, the eNB performs a same configuration for UEs in coverage of the eNB. As shown at block 2A02, the configuration may be directly performed, and the UE is not notified.

FIG. 2B is a flowchart illustrating a second method for supporting ProSe configuration for a UE according to an embodiment of the present invention. In this method, a target eNB obtains a ProSe configuration requirement from a source eNB, so that the ProSe configuration is performed for the UE. As shown in FIG. 2B, the method includes procedures as follows.

At block 2B01, the source eNB requests the target eNB to perform ProSe configuration for the UE, and indicates a ProSe configuration requirement. The ProSe configuration requirement is same as that at block 2A01, which is not described repeatedly.

The source eNB may indicate the ProSe configuration requirement to the target eNB in a handover process. Alternatively, according to a request from the target eNB, the source eNB may return the ProSe configuration requirement to the target eNB.

The source eNB may obtain a ProSe capability supported by a neighbor cell from a measurement report of the UE. Alternatively, the source eNB may obtain the ProSe capability supported by a neighbor cell through interaction via an X2 interface. According to a ProSe capability supported by a target cell, the source eNB may preferably select a target cell of supporting the ProSe for the UE using the ProSe.

A ProSe capability supported by a cell or an eNB is a capability of supporting the ProSe requested by the UE. The ProSe capability supported by a cell or an eNB may be a general capability whether the ProSe is supported (including a capability of discovering a ProSe and a capability of ProSe communication), or may further divided into the capability of discovering a ProSe and the capability of ProSe communication. The ProSe capability supported by a cell or an eNB may be further divided into a capability whether it is supported to configure sharing resources for the ProSe of the UE and a capability whether it is supported to configure dedicated resources for the ProSe of the UE. The ProSe capability supported by a cell or an eNB may be further divided into a capability whether a central scheduling for the ProSe of the UE is supported and a capability whether it is supported to obtain distributional resources for the UE. Considering whether ProSes at block 2A01 are supported, the ProSe capability supported by a cell or an eNB may be further subdivided.

Furthermore, when selectable target cells may not have a ProSe capability and there is not an infrastructure network bearer for the UE, the source eNB may not initiate handover. Alternatively, when the handover is initiated, the source eNB may not indicate the ProSe configuration requirement to the target eNB, may release resources configured for the ProSe of the UE before or after the handover.

Furthermore, if selectable target cells may not have a ProSe capability and there is an infrastructure network bearer for the UE, when initiating handover, the source eNB may not indicate the ProSe configuration requirement to the target eNB, and may release resources configured for the ProSe of the UE before or after the handover.

At block 2B02, according to the ProSe configuration requirement, the target eNB performs ProSe configuration for the UE. Operation content at block 2B02 is same as that at block 2A01, which is not described repeatedly herein.

At block 2B03, the target eNB may directly notify to the UE information of the ProSe configuration, or may notify to the UE the information of the ProSe configuration via the source eNB.

Information of the ProSe configuration for the UE is as illustrated at block 2A03, which is not described repeatedly herein.

FIG. 2C is a flowchart illustrating a third method for supporting ProSe configuration for a UE according to an embodiment of the present invention. In this method, a UE triggers a ProSe through a MME or a ProSe Function, and transmits a ProSe configuration requirement to an eNB through the MME or the ProSe Function. As shown in FIG. 2C, the method includes procedures as follows.

At block 2C01, the UE initiates a ProSe request to the MME or the ProSe Function.

The UE obtains a ProSe capability supported by a cell or an eNB which is described at block 2B01 from a cell broadcast. For the ProSe supported by an eNB accessed, the UE initiates the ProSe request to the MME or the ProSe Function via the eNB.

The ProSe request may be a ProSe initial request, a ProSe resource configuration request or a ProSe resource active request.

The ProSe request may indicate a ProSe type of a requested ProSe. The ProSe type is as described at block 2A01, which is not described repeatedly herein.

When the eNB forwards the ProSe request of the UE to the MME, the ProSe request carries the ProSe capability supported by the eNB.

When the MME forwards the ProSe request of the UE to the ProSe Function, the ProSe request carries the ProSe capability supported by the eNB. The MME may obtain the ProSe capability supported by the eNB from an S1 message of S1 interface establishment or from an S1 message of transmitting UE related information from the eNB. According to an APN provided by the UE or a default APN in a HSS, the MME may select a ProSe Function serving the UE. Alternatively, when there is a direct interface between the eNB and the ProSe Function, the eNB may directly transmit the ProSe capability to the ProSe Function.

At block 2C02, according to ProSe subscription of the UE, the ProSe Function or the MME performs request authentication. For a request passing through the authentication, the ProSe Function or MME indicates the eNB to perform the ProSe configuration for the UE.

The ProSe subscription of the UE may include information whether the ProSe is allowed, may include information whether the ProSe is allowed to be used for the UE (including a ProSe discovery and a ProSe communication), may be further subdivided into information whether the ProSe discovery service and/or the ProSe direct communication service is allowed to be used for the UE. Furthermore, the information whether the proximate discovery service and/or the ProSe direct communication service is allowed to be used for the UE may be subdivided according to block 2A01.

When the ProSe Function or the MME performs the ProSe authentication for the UE, according to the ProSe capability supported by the eNB, the ProSe request of the UE is authenticated. The ProSe supported by the eNB can pass through the authentication.

Blocks 2C03-2C05 are same with blocks 2A01-2A03, which are not described repeatedly herein.

FIG. 2D is a flowchart illustrating a fourth method for supporting ProSe configuration for a UE according to an embodiment of the present invention. In this method, the UE using the ProSe may directly transmit a ProSe request to a target eNB. The target eNB obtains a ProSe configuration requirement from a source eNB. As shown in FIG. 2D, the method includes procedures as follows.

At block 2D01, the UE initiates the ProSe request to the target eNB to indicate identifier information of the source eNB and/or identifier information of the UE in the source eNB.

The identifier information of the source eNB may be an identifier of the source eNB, an IP address of the source eNB or an identifier of a source cell. The source eNB is an eNB that performs ProSe configuration for the UE and stores the ProSe configuration request of the UE.

The identifier information of the UE in the source eNB may be a UE identifier (IMSI, S-IMSI or GUTI), an identifier (C-RNTI) configured for the UE by the source eNB, a resource identifier configured for the ProSe, a ProSe identifier, or a group identifier.

A ProSe capability supported by a target cell or a target eNB is obtained from a cell broadcast. The ProSe capability supported by the cell or the eNB is as described at block 2B01. The UE initiates the ProSe request to the eNB for the ProSe supported by the accessed target eNB.

The ProSe request may be a ProSe initial request, a ProSe resource configuration request, or a ProSe resource active request.

The ProSe request may indicate a requested ProSe type. The ProSe type is as described at block 2A01, which is not described repeatedly herein.

At block 2D02, according to the identifier information of the source eNB, the target eNB determines the source eNB, and transmits a request of obtaining a ProSe context of the UE to the source eNB to indicate the identifier information of the UE.

At block 2D03, after obtaining the ProSe configuration requirement of the UE according to the identifier information of the UE, the source eNB transmits the ProSe configuration requirement of the UE to the target eNB.

The identifier of the UE is as described at block 2D01. The ProSe configuration requirement of the UE is as described at block 2A01.

Blocks 2D04-2D05 are respectively same with blocks 2B02-2B03, which are not described repeatedly herein.

For D2D communication, service continuity is not considered, and communication content at different times may be respectively transmitted on different bearers. Thus, handover may be not performed, and the UE directly initiates the ProSe request to the target eNB, as described in a method in FIG. 2D.

So far, four basic processes of a method for supporting ProSe configuration for a UE ends. Detail embodiment as follows can illustrate detail implementation of the basic processes above.

### Embodiment 1

In the embodiment, after receiving a ProSe request initiated by the UE using a ProSe, a ProSe Function transmits a ProSe configuration requirement of the UE to an eNB via a MME. The method corresponds to a basic process in FIG. 2C.

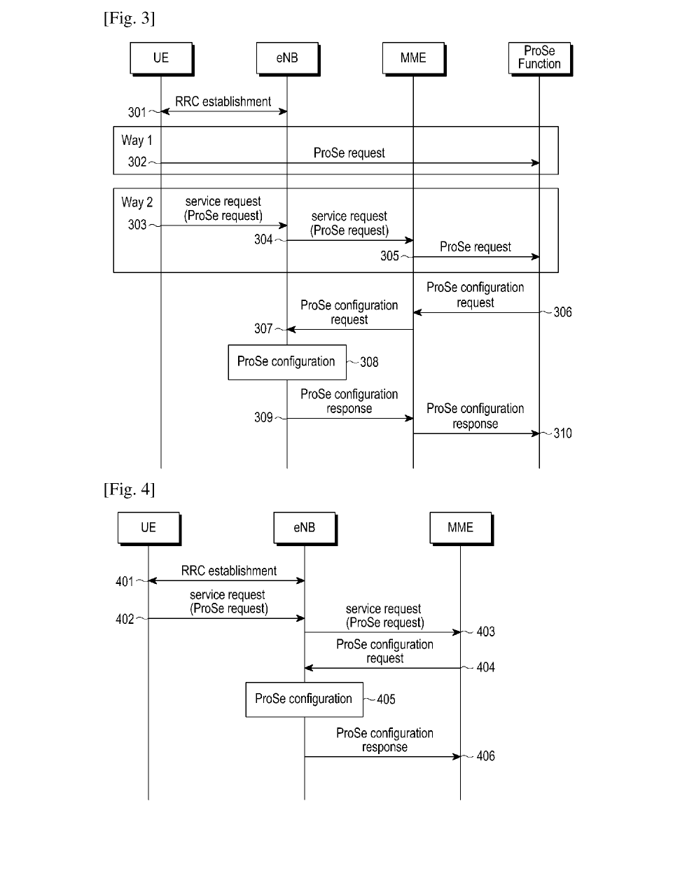

FIG. 3 is a flowchart illustrating a method for supporting ProSe configuration for a UE according to embodiment 1 of the present invention. In a RRC idle state, a UE initiates a ProSe request to a ProSe Function. The method includes procedures as follows.

At block 301, a UE establishes a RRC connection with an eNB.

The UE initiates the ProSe request to the ProSe Function serving the UE. In particular, there are two ways, respectively at block 302 and at blocks 303-305.

At block 302, the UE establishes a connection with the ProSe Function, directly initiates the ProSe request to the ProSe Function. The ProSe request indicates a ProSe type. The proximate service type is as described at block 2A01.

At the same time, the UE may further indicate an identifier of a MME accessed by the UE in the ProSe request.

So far, a process of initiating the ProSe request through a first way ends, and then procedures at block 306 are performed.

At block 303, the UE transmits a service request to the eNB. In the service request, the ProSe request is indicated. In the ProSe request, a ProSe type is indicated. The ProSe type is as described at block 2A01. The service request is forwarded to the MME through the eNB.

At block 304, the eNB forwards the service request of the UE to the MME, and indicates a ProSe capability supported by the eNB at the same time. The ProSe capability supported by the eNB is as described at block 2B01.

At block 305, the MME directly transmits the received ProSe request to the ProSe Function.

The ProSe request of the UE may include an APN of the ProSe. According to the APN provided by the UE or a default APN of the UE in a HSS, the MME may select the ProSe Function serving the UE.

So far, a process of initiating the ProSe request through a second way ends, and then procedures at block 306 are performed. In this way, the eNB forwards the service request received from the UE to the ProSe Function through the MME. In an implementation processing, when there is a direct interface between the eNB and the ProSe Function, the eNB may directly forward the service request of the UE to the ProSe Function.

At block 306, according to ProSe subscription of the UE, the ProSe Function performs authentication for the ProSe request of the UE. The ProSe subscription of the UE is as described at block 2C01. At the same time, the ProSe request of the UE transmitted from the MME to the ProSe Function may include a ProSe capability of the eNB. In an authentication process, the ProSe Function may further consider the ProSe capability of the eNB. Only the ProSe request supported by the eNB can pass through the authentication. The ProSe capability supported by the eNB is as described at block 2B01

For the UE passing through the authentication, the ProSe Function transmits a ProSe configuration request to the MME to indicate the ProSe configuration request. The ProSe configuration request is as described at block 2A01.

At block 307, the MME transmits the ProSe configuration request to the eNB. The ProSe configuration request may be a new S1 message, an initial UE context establishment request message, a UE context modification request message, or an E-RAB establishment request message. In the message, the ProSe configuration requirement of the UE may be indicated. The ProSe configuration requirement is as described at block 306. The MME may transmit the ProSe configuration requirement to the eNB through three ways.

1) The MME indicates a ProSe resource configuration request through an IE of E-RAB establishment, and indicates the eNB to omit essential information in a process of the E-RAB establishment, e.g., a transmission layer address, a GTP-TEID.

2) The MME indicates a ProSe configuration request through a new IE. When a default bearer is not required to be established for the UE, the MME may indicate the eNB to omit an E-RAB establishment list.

3) The MME transmits a ProSe configuration request through a newly-defined signal.

At block 308, according to the ProSe configuration requirement, the eNB performs ProSe configuration for the UE. Detail configuration content is as described at block 2A02.

At block 309, the eNB transmits a ProSe configuration response to the MME. The response may be a new S1 message, an initial UE context establishment response message, a UE context modification response message or, an E-RAB establishment response message.

At block 310, the MME transmits a resource configuration response to the ProSe Function.

In a process at blocks 306-310, the ProSe Function transmits the ProSe configuration requirement to the MME. The eNB performs a response to the ProSe Function through the MME. In a practical processing, when there is a direct interface between the eNB and the ProSe Function, the ProSe Function may directly transmit the ProSe configuration requirement to the eNB. After completing the ProSe configuration, the eNB directly performs a configuration response to the ProSe Function.

So far, the process in embodiment 1 ends.

### Embodiment 2

In this embodiment, after receiving a ProSe request of a UE using a ProSe, a MME triggers an eNB to perform ProSe configuration to the UE.

FIG. 4 is a flowchart illustrating a method for supporting ProSe configuration for a UE according to embodiment 2 of the present invention. In a RRC idle state, a UE initiates a ProSe request to a ProSe Function. The method includes procedures as follows.

At block 401, a UE establishes a RRC connection with an eNB.

At block 402, the UE transmits a service request to the eNB. In the service request, a ProSe request is indicated. In the ProSe request, a ProSe type is indicated. The ProSe type is as described at block 2A01. The service request is firstly transmitted to the eNB, and then is forwarded to the MME through the eNB.

At block 403, the eNB forwards the service request of the UE to the MME, and indicates the ProSe capability supported by the eNB at the same time. The ProSe capability of the eNB is as described at block 2B01.

At block 404, according to the ProSe capability supported by the eNB and/or ProSe subscription of the UE, the MME performs ProSe authentication for the UE. The ProSe capability supported by the eNB and the ProSe subscription of the UE are respectively as described at block 2C01.

The MME obtains the ProSe subscription of the UE through the HSS and the ProSe Function.

For the ProSe request of the UE passing through the authentication, procedures at block 405 are performed.

Blocks 405-406 are same with blocks 307-309, which are not described repeatedly herein.

So far, the process in embodiment 2 ends.

### Embodiment 3

FIG. 5 is a flowchart illustrating a method for supporting ProSe configuration for a UE according to embodiment 3 of the present invention. In a process that a UE is using a ProSe, an X2 handover occurs. A source eNB indicates a ProSe configuration requirement of the UE to a target eNB. The source eNB transmits to the UE information configured by the target eNB for the ProSe of the UE. The method includes procedures as follows.

At block 501, the UE may obtain a ProSe capability supported by a neighbor cell through measurement. The ProSe capability is as described at block 2B01. The UE transmits a measurement report to the source eNB, wherein the measurement report transmitted from the UE to the source eNB may include the ProSe capability of the neighbor cell.

According to the measurement report of the UE, the source eNB preferably selects a target cell supporting the ProSe for the UE using the ProSe.

When all selectable target cells do not support the ProSe capability and/or there is not an infrastructure network bearer for the UE, the source eNB may not initiate handover. Alternatively, the source eNB may not indicate the ProSe configuration requirement to the target eNB when the handover is initiated, and releases resources configured for the ProSe of the UE before or after the handover.

When all selectable target cells do not support the ProSe capability and there is not an infrastructure network bearer for the UE, the source eNB may not indicate the ProSe configuration requirement to the target eNB when the handover is initiated, and releases resources configured for the ProSe of the UE before or after the handover.

At block 502, the source eNB initiates a handover request or a ProSe configuration request to the target eNB to indicate the ProSe configuration requirement. The ProSe configuration requirement is as described at block 2A01.

At block 503, according to the ProSe configuration requirement, the target eNB determines whether ProSe configuration is performed for the UE. A configuration process is as described at block 2B02.

At block 504, the target eNB transmits a handover request acknowledge or a ProSe configuration response to the source eNB. The handover request acknowledge or a ProSe configuration response may further include information configured for the ProSe of the UE by the target eNB. The information configured for the ProSe of the UE is as described at block 2B02.

At block 505, the source eNB indicates RRC connection reconfiguration message to the UE to perform a RRC connection reconfiguration, wherein the message may include configuration for the ProSe of the UE configured by the target eNB.

At block 506, the UE transmits a RRC reconfiguration complete to the target eNB to access the target eNB.

At block 507, the target eNB transmits UE context release or resource release to the source eNB to indicate the source eNB to release resources configured for the ProSe of the UE.

At block 508, the target eNB transmits a path switch request or a new S1 message to MME. The message may indicate the ProSe configuration of the UE has been reconfigured by the target eNB.

At block 509, the MME transmits a path switch request acknowledge to the target eNB.

So far, the process in embodiment 3 ends.

### Embodiment 4

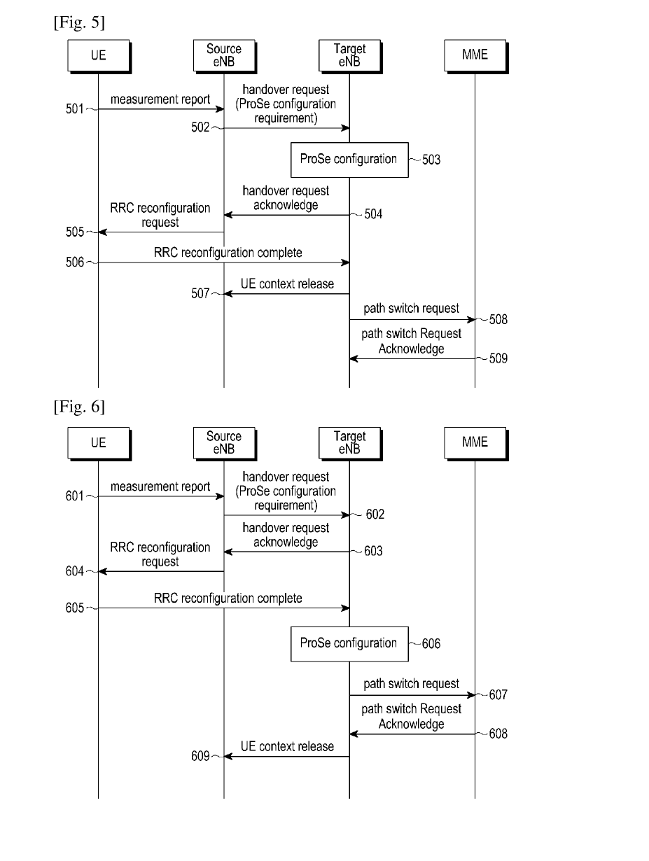

FIG. 6 is a flowchart illustrating a method for supporting ProSe configuration for a

UE according to embodiment 4 of the present invention. In a process that a UE is using a ProSe, an X2 handover occurs. A source eNB indicates a ProSe configuration requirement of the UE to a target eNB. After the UE accesses the target eNB, the target eNB transmits to the UE information configured for the ProSe of the UE. The method includes procedures as follows.

Blocks 601-602 are respectively as described at blocks 501-502, which are not described repeatedly herein.

At block 603, according to the ProSe configuration requirement, the target eNB determines whether the ProSe configuration is performed for the UE. A configuration process is as described at block 2B02.

The target eNB transmits a handover request acknowledge or a ProSe configuration response to the source eNB.

At block 604, the source eNB indicates the UE to perform a RRC reconfiguration.

At block 605, the UE transmits a RRC reconfiguration complete to the target eNB to access the target eNB.

At block 606, the target eNB notifies to the UE information configured for the ProSe of the UE. The information configured for the ProSe of the UE is as described at block 2B02.

At block 607, the target eNB transmits a path switch request or a new S1 message to the MME. The message may indicate the ProSe configuration for the UE has been reconfigured by the target eNB.

At block 608, the MME transmits a path switch request acknowledge to the target eNB.

At block 609, the target eNB transmits to the source eNB a UE context release or a resource release to indicate the source eNB to release resources configured for the ProSe of the UE.

So far, the process in embodiment 4 ends. Comparing with embodiment 3, in this embodiment, the information configured by the target eNB for the UE to perform the ProSe is not reconfigured for the UE through the source eNB. Thus, handover preparation time is reduced, handover efficiency and ProSe configuration efficiency are improved, and successful efficiency is improved.

### Embodiment 5

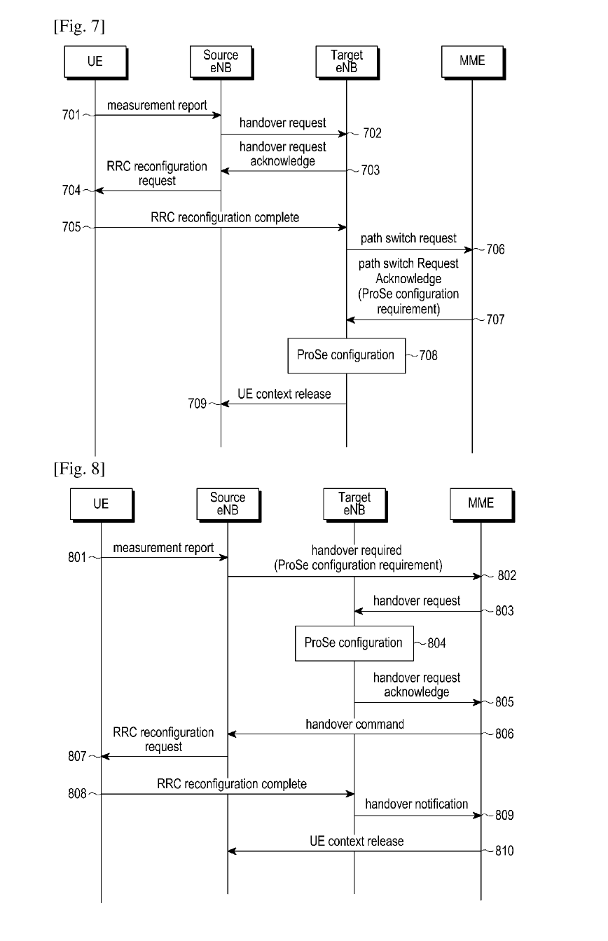

FIG. 7 is a flowchart illustrating a method for supporting ProSe configuration for a UE according to embodiment 5 of the present invention. In a process that a UE is using a ProSe, an X2 handover occurs. A MME indicates a ProSe configuration requirement of the UE to a target eNB. The method includes procedures as follows.

At block 701, the UE obtains a ProSe capability supported by a neighbor cell through measurement. The ProSe capability is as described at block 2B01. A measurement report transmitted from the UE to the source eNB includes the ProSe capability supported by the neighbor cell.

According to the measurement report of the UE, the source eNB preferably selects a target cell supporting the ProSe for the UE using the ProSe, and initiates handover.

At block 702, the source eNB transmits a handover request to the target eNB.

At block 703, the target eNB transmits a handover request acknowledge to the source eNB.

At block 704, the source eNB indicates the UE to perform a RRC reconfiguration.

At block 705, the UE transmits a RRC reconfiguration complete to the target eNB to access the target eNB.

At block 706, the target eNB transmits a path switch request to the MME.

At block 707, the MME transmits a path switch request acknowledge to the target eNB to indicate a ProSe configuration requirement of the UE. The ProSe configuration requirement is as described at block 2B01.

At block 708, according to the ProSe reconfiguration requirement, the target eNB determines whether the ProSe reconfiguration is performed for the UE. A reconfiguration process is as described at block 2B02.

At block 709, the target eNB transmits to the source eNB a UE context release or a resource release to indicate the source eNB to release resources configured for the ProSe of the UE.

So far, the process in embodiment 5 ends.

### Embodiment 6

FIG. 8 is a flowchart illustrating a method for supporting ProSe configuration for a UE according to embodiment 6 of the present invention. In a process that a UE is using a ProSe, an S1 handover occurs. A source eNB or a MME indicates a ProSe configuration requirement of the UE to a target eNB. The source eNB transmits to the UE information configured by the target eNB for the ProSe of the UE. The method includes procedures as follows.

Block 801 is same with block 501, which is not described repeatedly herein.

At block 802, the source eNB initiates a handover required or a ProSe configuration request to the MME. A message (e.g. handover request or ProSe configuration request) may indicate a ProSe configuration requirement. The ProSe configuration requirement is as described at block 2B01.

At block 803, the MME transmits a handover request or the ProSe configuration request to the target eNB. The ProSe configuration requirement in the message (handover request or ProSe configuration request) may be from the source eNB or the MME.

Block 804 is same with block 503, which is not described repeated herein.

At block 805, the target eNB transmits a handover request acknowledge or a ProSe configuration response to the MME. The handover request acknowledge or the ProSe configuration response includes information configured for the ProSe of the UE. The information configured for the ProSe of the UE is as described at block 2B02.

At block 806, the MME transmits a handover command or a ProSe reconfiguration command. The handover command or the ProSe reconfiguration command includes the information configured for the ProSe of the UE.

At block 807, the source eNB indicates the UE to perform RRC reconfiguration. A message indicating the UE to perform RRC reconfiguration includes configuration for the ProSe of the UE configured by the target eNB.

At block 808, the UE transmits a RRC reconfiguration complete to the target eNB, to access the target eNB.

At block 809, the target eNB transmits a handover notification to the MME.

At block 810, the MME transmits a UE context release to the source eNB.

So far, the process in embodiment 6 ends.

### Embodiment 7

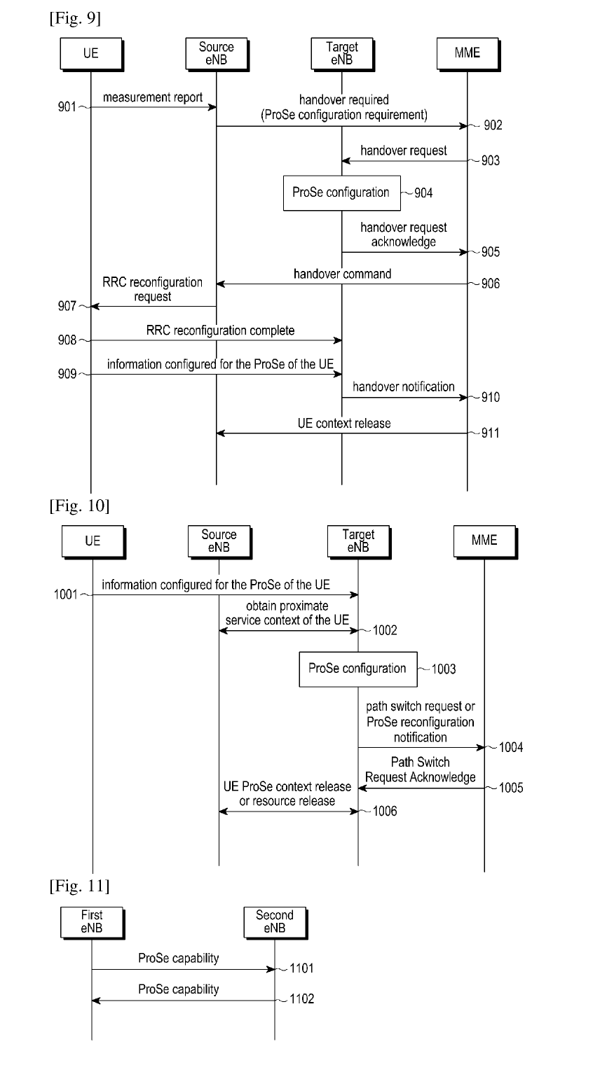

FIG. 9 is a flowchart illustrating a method for supporting ProSe configuration for a UE according to embodiment 7 of the present invention. In a process that a UE is using a ProSe, an S1 handover occurs. A source eNB or a MME indicates a ProSe configuration requirement of the UE to a target eNB. After the UE accesses the target eNB, the target eNB transmits to the UE information configured for a ProSe of the UE. The method includes procedures as follows.

Blocks 901-904 are same with block 801-804, which are not described repeatedly herein.

At block 905, the target eNB transmits a handover request acknowledge or a ProSe configuration response to the MME. Block 904 and block 905 may be performed at the same time.

At block 906, the MME transmits a handover command or a ProSe reconfiguration command to the source eNB.

At block 907, the source eNB indicates the UE to perform RRC reconfiguration.

At block 908, the UE transmits a RRC reconfiguration complete to the target eNB to access the target eNB.

At block 909, the UE notifies to the UE information configured for the ProSe of the UE. The information configured for the ProSe of the UE is as described at block 2B02.

At block 910, the target eNB transmits a handover notification to the MME.

At block 911, the MME transmits a UE context release to the source eNB.

So far, the process in embodiment 7 ends. Similarly with embodiment 4, in this embodiment, the information configured for the ProSe of the UE by the target eNB may be reconfigured for the UE through the source eNB. Thus, handover preparation time is reduced, handover efficiency and ProSe configuration efficiency are improved, and successful efficiency is improved.

### Embodiment 8

FIG. 10 is a flowchart illustrating a method for supporting ProSe configuration for a UE according to embodiment 8 of the present invention. After an eNB performs ProSe configuration for the UE, when moving to a new cell or a new eNB in a ProSe process, a UE may request the eNB to perform ProSe reconfiguration. The target eNB may obtain a ProSe configuration requirement from the source eNB. The method includes procedures as follows.

At block 1001, the UE moves to coverage of the target eNB, transmits a ProSe reconfiguration request to the target eNB to indicate identifier information of the source eNB. The identifier information of the source eNB is as described at block 2D01.

Furthermore, when transmitting the ProSe reconfiguration request to the target eNB, the UE provides identifier information of the UE in the source eNB. The identifier information of the UE in the source eNB is as described at block 2D01.

At block 1002, according to the identifier information of the source eNB, the target eNB determines the source eNB, obtains ProSe context of the UE, and indicates identifier information of the UE as described at block 1001.

At block 1003, according to the ProSe context of the UE, the target eNB determines whether ProSe reconfiguration is performed for the UE. When it is determined that ProSe reconfiguration is performed for the UE, the target eNB transmits to the UE information configured for the ProSe of the UE. The information configured for the ProSe of the UE is as described at block 2B02.

At block 1004, the target eNB transmits a path switch request or a ProSe reconfiguration notification to the MME to indicate that the UE has moved to the target eNB.

At block 1005, the MME transmits the ProSe reconfiguration notification to the ProSe Function. Procedures at this block are optional.

At block 1006, the target eNB indicates the source eNB to perform UE ProSe context release or ProSe resource release.

So far, the process in embodiment 8 ends.

### Embodiment 9

In three embodiments above, a source eNB is required to select a target eNB supporting a ProSe for a UE. In this embodiment, a process of obtaining information whether a ProSe is supported by a neighbor node is illustrated, which includes procedures as follows.

FIG. 11 is a flowchart illustrating a method for supporting ProSe configuration for a

UE according to embodiment 9 of the present invention. A process of exchanging ProSe capabilities between an eNB and a neighbor eNB includes procedures as follows.

At block 1101, a first eNB is neighbor from a second eNB. The first eNB transmits a ProSe capability supported by the first eNB to the second eNB. The ProSe capability supported by the eNB is as described at block 2B01.

At block 1102, the second eNB returns a ProSe capability supported by the second eNB to the first eNB.

So far, the process in embodiment 9 ends.

In the process above of the present invention, when performing monitoring configuration for the UE using the ProSe, the eNB may perform neighbor cell monitoring configuration for the UE. In embodiment 10 as follows, a process of exchanging monitoring configuration among neighbor cells is illustrated.

### Embodiment 10

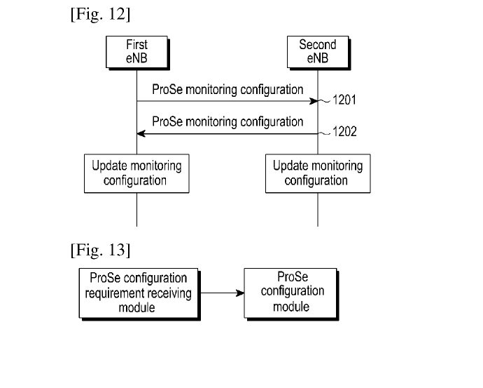

FIG. 12 is a flowchart illustrating a method for supporting ProSe configuration for a UE according to embodiment 10 of the present invention. In FIG. 12, a process of exchanging cell ProSe monitoring configuration between an eNB and a neighbor eNB is illustrated. The monitoring configuration corresponds to ProSe configuration performed according to a configuration requirement of monitoring resources. The method includes procedures as follows.

At block 1201, a first eNB is neighbor from a second eNB. The first eNB transmits ProSe monitoring configuration of a cell belonging to the first eNB, i.e., transmission time-frequency resources to be monitored.

At block 1202, the second eNB returns ProSe monitoring configuration of a cell belonging to the second eNB to the first eNB.

So far, the process in embodiment 10 ends.

Detail implementations according to a method for configuring ProSe resources of the present invention are illustrated above. A radio network node device is provided to implement the method for configuring ProSe resources. FIG. 13 is a schematic diagram illustrating a structure of a radio network node device according to an embodiment of the present invention. As shown in FIG. 13, the device includes a ProSe configuration requirement receiving module and a ProSe configuration module.

The ProSe configuration requirement receiving module is configured to receive a ProSe configuration requirement, trigger the ProSe configuration module to perform ProSe configuration.

The ProSe configuration module is configured to perform the ProSe configuration for the UE according to the ProSe configuration requirement received by the ProSe configuration requirement receiving module.

The method provided according to a technical solution of the present invention is used to configure multiple ProSes for the UE using a ProSe. In a scenario that the UE is moving, different solutions are provided. Especially, flexible solutions are provided for an eNB to obtain a ProSe capability. A flexible solution is provided for a proximate discovery solution according to the present invention so as to provide diversification network experience for the UE and to satisfy common security and a communication service requirement in a social network field.

The foregoing is only preferred examples of the present invention and is not used to limit the protection scope of the present invention. Any modification, equivalent substitution and improvement without departing from the spirit and principle of the present invention are within the protection scope of the present invention.

1. A method for supporting proximity-based service (ProSe) configuration for a user equipment (UE), the method comprising:
receiving a ProSe configuration requirement, wherein the ProSe configuration requirement is used to request ProSe configuration for the UE; and
performing the ProSe configuration for the UE according to the ProSe configuration requirement.

2. The method of claim 1, wherein the ProSe configuration requirement comprises a ProSe type comprising at least one service type or a combination of at least two service types as follows: a proximate discovery service, a ProSe direct communication service, a proximate discovery service of discovering another UE, a proximate discovery service to be discovered by another UE, a proximate discovery service of the UE, a proximate discovery service for a designated target UE, a ProSe via UE sharing resources, a ProSe via UE dedicated resources, a ProSe direct communication service, an one-to-one ProSe direct communication service, an one-to-multiple ProSe direct communication service, a direct ProSe, a ProSe via a relay, a ProSe assisted via a network, and/or a ProSe by centrally scheduling resources, and/or a proximate server that the UE obtains resources.

3. The method of claim 2, wherein the ProSe configuration requirement comprises different ProSe configuration requirements, respectively, corresponding to different the multiple service types when the ProSe type comprises multiple service types or a combination of the multiple service types.

4. The method of claim 3, wherein the ProSe configuration requirement corresponding to the ProSe direct communication service further comprises UE group information comprising a group identifier or a grouping filter condition.

5. The method of claim 1, wherein the ProSe configuration requirement comprises a UE type, and wherein the UE type comprises at least one of a UE transmitting a signal or a UE monitoring a signal.

6. The method of claim 1, wherein the ProSe configuration requirement comprises a ProSe priority of the UE to provide that a radio network node accessed by the UE or a handover target radio network node perform scheduling and resource configuration according to the ProSe priority of the UE.

7. The method of claim 1, wherein receiving, from a radio network node, the ProSe configuration requirement further comprises performing the ProSe configuration with the radio network node.

8. The method of claim 7, wherein the radio network node comprises at least one of a radio network node accessed by the UE or a target radio network node.

9. The method of claim 1, wherein the ProSe configuration requirement is transmitted by a at least one of a ProSe function or a core network node.

10. The method of claim 9, wherein the at least on of the ProSe function or the core network node transmitting the ProSe configuration requirement comprises at least one of:
receiving, by the core network node, a ProSe request transmitted by the UE via a radio network node accessed by the UE; and
transmitting the ProSe configuration requirement after the UE passes through authentication according to at least one of ProSe subscription of the UE or a ProSe capability of the radio network node accessed by the UE to request the ProSe configuration for the UE; or
receiving, by the ProSe Function, a ProSe request at least one of directly transmitted by the UE or transmitted by the UE via the radio network node accessed by the UE; and
transmitting the ProSe configuration requirement after the UE passes through authentication according to at least one of ProSe subscription of the UE or a ProSe capability of the radio network node accessed by the UE to request the ProSe configuration for the UE.

11. The method of claim 10, wherein the ProSe capability of the radio network node accessed by the UE comprises at least one of
a capability whether the ProSe is supported, a capability whether a proximate discovery service is supported, a capability whether a ProSe direct communication service is supported, a capability whether the proximate discovery service of discovering another UE is supported, a capability whether the proximate discovery service to be discovered by another UE is supported, a capability whether the proximate discovery service of the UE is supported, a capability whether the proximate discovery service for a designated target UE is supported, a capability whether the ProSe direct communication service is supported, a capability whether a one-to-one ProSe direct communication service is supported, a capability whether a one-to-multiple ProSe direct communication service is supported, a capability whether the direct ProSe is supported, a capability whether the ProSe via a relay is supported, a capability whether the ProSe assisted via a network is supported, a capability whether sharing resources are configured for the ProSe of the UE is supported, a capability whether dedicated resources are configured for the ProSe of the UE is supported, a capability whether the ProSe by centrally scheduling resources is supported, or a capability whether the ProSe that the UE obtains distributional resources is supported; and
wherein the ProSe subscription comprises at least one of whether the UE is allowed to use the ProSe, whether the UE is allowed to use the proximate discovery service, the UE is allowed to use the ProSe direct communication service, whether the UE is allowed to use the proximate discovery service of discovering another UE, whether the UE is allowed to use the proximate discovery service to be discovered by another UE, whether the UE is allowed to use the proximate discovery service of the UE, whether the UE is allowed to use the proximate discovery service for a designated target UE, whether the UE is allowed to the ProSe direct communication service, whether the UE is allowed to the one-to-one ProSe direct communication service, whether the UE is allowed to the one-to-multiple ProSe direct communication service, a capability whether the direct ProSe, whether the UE is allowed to the ProSe via a relay is supported, a capability whether the ProSe assisted via a network, whether the UE is allowed to the ProSe via sharing resources, whether the UE is allowed to the ProSe via dedicated resources, whether the UE is allowed to the ProSe by centrally scheduling resources, or whether the UE is allowed to use a proximate server that UE obtains distributed resources.

12. The method of claim 10, further comprising at least one of:
obtaining, by the core network node, the ProSe capability of the radio network node accessed by the UE via the radio network node accessed by the UE; or
obtaining, by the ProSe function, the ProSe capability of the radio network node accessed by the UE via the radio network node accessed by the UE.

13. The method of claim 1, wherein the ProSe configuration requirement transmitted from a source radio network node of the UE to a target radio network node of the UE comprises the ProSe configuration performed by the target radio network node.

14. The method of claim 13, wherein the target radio network node receiving the ProSe configuration requirement transmitted from the source radio network node comprises at least one of:
after the UE moves from coverage of the source radio network node to a coverage of the target radio network node, receiving, by the target radio network node, a ProSe configuration request transmitted by the UE, wherein the ProSe configuration request carries at least one of identifier information of the source radio network node or identifier information of the UE in the source radio network node;
determining, by the target radio network node, the source radio network node according to the at least one of the identifier information of the source radio network node transmitted by the UE or the identifier information of the UE in the source radio network node; and
obtaining ProSe context of the UE comprising the ProSe configuration requirement from the source radio network node; or
receiving, by the target radio network node, a ProSe configuration request at least one of directly transmitted from the source radio network node or transmitted through the core network node, wherein the ProSe configuration requirement is indicated in the ProSe configuration request, and wherein the target radio network node is selected by the source radio network node for the UE; or
transmitting, by the target radio network node, at least one of a ProSe context request of the UE or a ProSe configuration requirement request of the UE to the source radio network node; and
receiving the ProSe configuration requirement responded from the source radio network node.

15. The method of claim 14, wherein the identifier information of the source radio network node comprises at least one of first identifier information or second identifier information, the first identifier information including at least one of an identifier of the source radio network node, an IP address of the source radio network node, or an identifier of a source cell, the second identifier information including at least one of the identifier information of the UE in the source radio network node comprises a UE identifier, an identifier configured for the UE by the source radio network node, a resource identifier configured for the ProSe of the UE, an identifier of the ProSe of the UE, or an identifier of a group to which the UE belongs.

16. The method of claim 14, wherein after the target radio network node performs the ProSe configuration for the UE, further comprising at least one of:
indicating, by the target radio network node, the source radio network node to release the ProSe context or ProSe resources;
notifying, by the target radio network node, the core network node that ProSe configuration for the UE is changed to ProSe configuration under the target radio network node; or
transmitting, by the target radio network node, configuration information to the UE directly or through the source radio network node.

17. The method of claim 14, wherein the target radio network node is selected by the source radio network node for the UE, when the source radio network node selects the target radio network node, and
wherein the source radio network node releases at least one of the ProSe context of the UE or ProSe resources of the UE before or after handover, when at least one of all selectable target radio network node do not support the ProSe, the source radio network node does not hand over the UE, or the source radio network node does not request the selected target radio network node to perform the ProSe configuration for the UE.

18. The method of claim 14, wherein before the target radio network node is selected by the source radio network node for the UE further comprising at least one of:
obtaining, by the source radio network node, at least one of a ProSe capability supported by a neighbor cell or a ProSe capability supported by a neighbor radio network node from a measurement report of the UE; or
obtaining, by the source radio network node, at least one of a ProSe capability supported by a neighbor cell or a ProSe capability supported by a neighbor radio network node by interacting via an X2 interface.

19. The method of claim 2, wherein:
when at least one of the ProSe type is a service type requiring transmission information or the UE is a UE of transmitting a signal, at least one of the radio network node accessed by the UE or the target radio network node performing the ProSe configuration for the UE comprises at least one of:
for sharing resources, indicating, by at least one of the radio network node accessed by the UE or the target radio network node, at least one of a sharing resource pool for the UE or the UE to monitor a broadcast of the sharing resource pool;
for dedicated resources, configuring, by at least one of the radio network node accessed by the UE or the target radio network node, dedicated resources for the UE; and
storing the ProSe context of the UE, the ProSe context of the UE comprising a UE identifier and information of the occupied dedicated resources;
when at least one of the ProSe type is a service type of requiring monitoring information or the UE is a UE of monitoring a signal, at least one of the radio network node accessed by the UE or the target radio network node performing the ProSe configuration for the UE comprises:
performing monitoring configuration for the UE; wherein performing the monitoring configuration for the UE comprises at least one of indicating the UE to monitor a broadcast of a monitoring resource pool or notifying the resource pool to be monitored to the UE;
when the ProSe configuration requirement is a configuration requirement of the ProSe of centrally scheduling resources, at least one of the radio network node accessed by the UE or the target radio network node performing the ProSe configuration for the UE comprises scheduling and configuring, by the radio network node, resources to be used in the ProSe;
when the ProSe configuration requirement is a configuration requirement of the ProSe that the UE obtains distributional resources, at least one of the radio network node accessed by the UE or the target radio network node performing the ProSe configuration for the UE comprises at least one of indicating the sharing resource pool for the UE, indicating the UE to monitor the broadcast of the ProSe sharing resource pool, or not performing configuration;
when the ProSe configuration requirement is a configuration requirement of the ProSe, at least one of the radio network node accessed by the UE or the target radio network node performing the ProSe configuration for the UE comprises:
when there are not dedicated resources configured for a group in the radio network node accessed by the UE or the target radio network node, configuring, by at least one of the radio network node accessed by the UE or the target radio network node, the sharing resources for the group; and
storing ProSe context, wherein the storing ProSe context comprises a UE group identifier and information of the sharing resources occupied by the group;
when the dedicated resources for the group have been configured, indicating, by at least one of the radio network node accessed by the UE or the target radio network node, the dedicated resources for the UE; and
adding the UE to the ProSe context; or
when the ProSe configuration requirement comprises a ProSe priority of the UE, performing, by at least one of the radio network node accessed by the UE or the target radio network node, scheduling and configuration according to the ProSe priority of the UE.

20. The method of claim 19, wherein performing the monitoring configuration for the UE comprises indicating at least one of the UE to monitor the monitoring configuration from a serving cell or a neighbor cell.

21. The method of claim 20, wherein before performing the monitoring configuration for the UE, further comprising:
transmitting, by at least one of the radio network node accessed by the UE or the target radio network node, the monitoring configuration of a cell belonging to the radio network node to a neighbor radio network node, and
receiving the monitoring configuration of a cell belonging to the neighbor radio network node.

22. A radio network node device comprising:
a ProSe configuration requirement receiving module configured to:
receive a ProSe configuration requirement; and
trigger a ProSe configuration module to perform ProSe configuration, wherein the ProSe configuration module is configured to perform the ProSe configuration for a UE according to the ProSe configuration requirement received by the ProSe configuration requirement receiving module.
